(19) United States
(12) Patent Application Publication
(10) Pub. No.: US 2013/0255261 A1
(43) Pub. Date: Oct. 3, 2013

(54) SWIRLER FOR COMBUSTION CHAMBERS

(71) Applicants: Bassam Sabry Mohammad Abdelnabi, Guilderland, NY (US); Ahmed Mostafa Elkady, West Chester, OH (US)

(72) Inventors: Bassam Sabry Mohammad Abdelnabi, Guilderland, NY (US); Ahmed Mostafa Elkady, West Chester, OH (US)

(73) Assignee: GENERAL ELECTRIC COMPANY, SCHENECTADY, NY (US)

(21) Appl. No.: 13/435,278

(22) Filed: Mar. 30, 2012

(51) Int. Cl. F23R 3/28; F02C 7/22

(52) U.S. Cl. 60/734; 416/185

(57) ABSTRACT

A combustion swirler is provided. The combustion swirler includes multiple vanes axially extending from an annular first body portion of the combustion swirler. The combustion swirler also includes an annular second body portion enclosing the multiple vanes for directing a flow of combustion fluid. Each of the vanes comprises an aerodynamic blade body comprising a leading edge with a plurality of first tubercles and a trailing edge with a plurality of second tubercles.

### BACKGROUND

The invention relates generally to combustors and more particularly to swirlers for combustion chambers.

Typically gas turbines include combustion chambers having swirlers along with fuel nozzles (or swozzles) therein. Each of the swirlers within a nozzle includes one or more passages for delivering a mixture of fuel and air (or air only) to a combustion chamber. The swozzles are used for stabilizing the flame and improving the mixing of the fuel and air prior to ignition. The swirler includes a plurality of vanes extending from the nozzle and having an aerodynamic profile. The swirler vanes often include passages which provide fuel to fuel holes on a surface of the swirler vanes. As fuel exits the fuel holes, it mixes with fluid, typically air, passing the swirler vanes. Typically the swirler vanes have a turn near the trailing edge of the swirler vane that may produce flow separations in the swirler or downstream of the swirler which increases the potential of flash back and flame holding to occur. To solve such flow problems, one common approach is to modify the vane profile. This modification requires new casting processes and casting tooling for each iteration.

Accordingly, there is an ongoing need for increasing the swirler performance.

### BRIEF DESCRIPTION

In accordance with an embodiment of the invention, a combustion swirler is provided. The combustion swirler includes multiple vanes axially extending from an annular first body portion of the combustion swirler. The combustion swirler also includes an annular second body portion enclosing the multiple vanes for directing a flow of combustion fluid. Each of the vanes comprises an aerodynamic blade body comprising a leading edge with a plurality of first tubercles and a trailing edge with a plurality of second tubercles.

In accordance with another embodiment of the invention, a gas turbine is provided. The gas turbine includes a combustion swirler located upstream of a combustion region of the gas turbine. Further, the combustion swirler includes multiple vanes axially extending from an annular first body portion of a combustion air swirler. The gas turbine also includes an annular second body portion of the swirler enclosing the multiple vanes for directing a flow of combustion fluid. Each of the vanes includes an aerodynamic blade body having a leading edge with multiple first tubercles and a trailing edge with multiple second tubercles.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-section view of an embodiment of a fuel nozzle for a gas turbine in accordance with an embodiment of the present invention.

FIG. 2 is perspective view of a combustion swirler in accordance with an embodiment of the present invention.

FIG. 3 is a perspective view of a combustion swirler in accordance with another embodiment of the present invention.

FIG. 4 shows a swirler vane of a combustion swirler in accordance with an embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

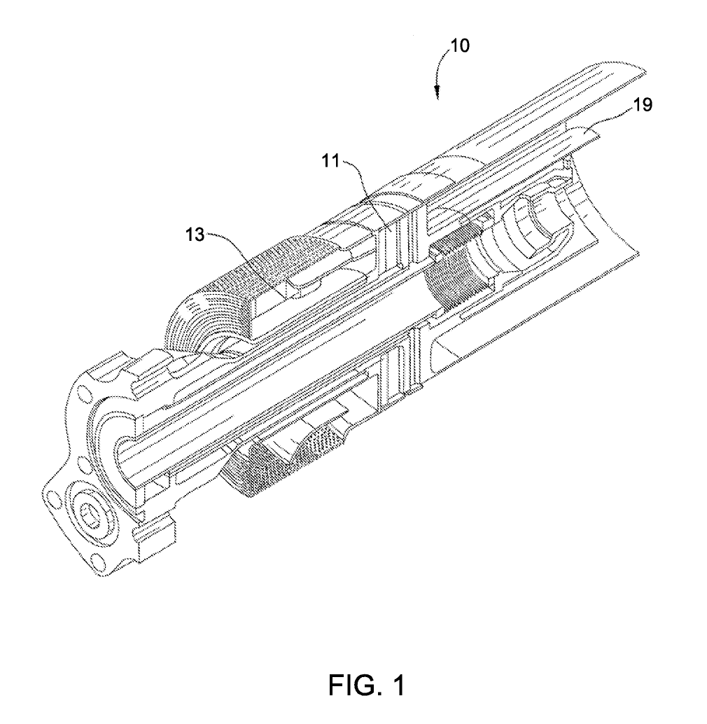

FIG. 1 shows a portion of a fuel nozzle 10 including a combustion swirler 11 in accordance with an embodiment of the present invention. The combustion swirler 11 is configured to receive a flow of combustion fluid, normally air, from a nozzle inlet 13 of a gas turbine and mix the air with a fuel into an air-fuel mixture. The air-fuel mixture then proceeds downstream for ignition in a combustion zone 19.

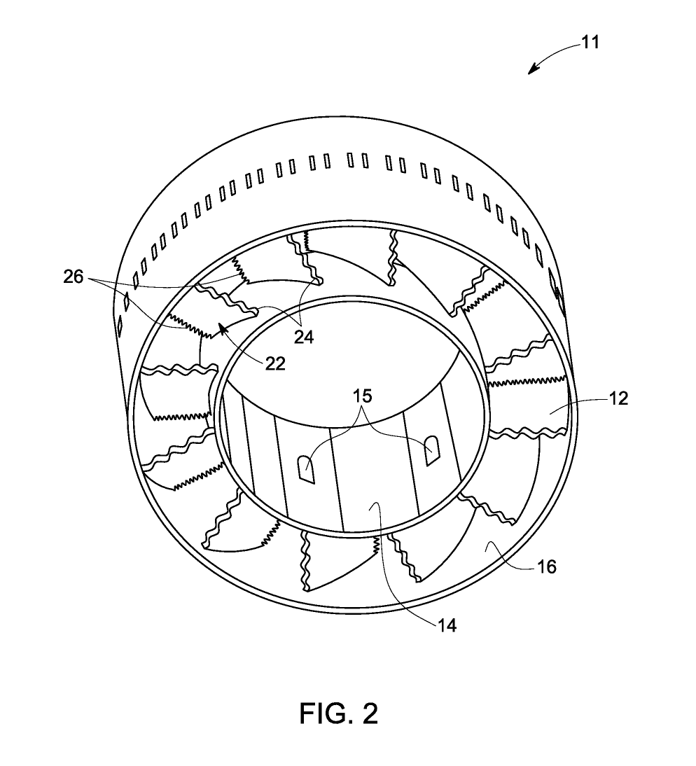

A perspective view of the combustion swirler 11 is shown in FIG. 2 in accordance with an embodiment of the present invention. As shown, the combustion swirler 11 includes multiple swirler vanes 12 arranged circumferentially around a center body 14 and extending to a shroud 16 for directing a flow of combustion fluid. The center body 14 has a cross-section that is capable of carrying the combustion fluid therethrough. Non-limiting examples of the combustion fluid include air, fuel, or combinations thereof The center body 14 is a first annular body portion of the combustion swirler 11 with one or more center body holes 15 for directing a portion of the combustion fluid through the plurality of center body holes 15 and the multiple swirler vanes 12. The plurality of swirler vanes 12 extends from the annular first body portion at an angle ranging from about 25 degrees to about 75 degrees with respect to a central axial axis along the center of the annular first body portion. The multiple swirler vanes 12 provide a twisting motion to the flow of combustion fluid causing a vortex like motion for improving the mixing of the combustion fluid and a fuel. Further, the shroud 16 comprises a second annular body portion enclosing the swirler vanes 12. In one embodiment, an inner surface of the second annular body portion of the shroud 16 is attached to the plurality of swirler vanes 12. The combustion swirler 11 of the embodiment of FIG. 1 may be produced as a casting in one embodiment, but other methods of fabrication including for example, welding or machining, are contemplated within the scope of the present invention.

Each of the multiple swirl vanes 12 includes an aerodynamic blade body comprising a leading edge 22 with a plurality of first tubercles 24. The first tubercles 24 are protrusions with sinuous curves at the leading edge 22. This will help generate a couple of counter rotating vortices around the leading edge 22 resulting in elimination of a flow separation close to a trailing edge 28 such that a lower swirl angle can be used while maintaining a same amount of swirl of the air or the mixture of fuel and air. This will be translated in terms of reduction in the pressure drop generated across the combustion swirler 11. Such a reduction in pressure drop leads to an increase in thermal efficiency of the gas turbine having the combustion swirler 11. Further, the leading edge 22 with the plurality of first tubercles 24 causes elimination of the trailing edge wake region, thereby resulting in improved flame static stability. In one embodiment, the leading edge 22 with the plurality of first tubercles 24 causes a high speed flow of the combustion fluid without forming any wake region.

The aerodynamic blade body of each of the multiple swirler vanes 12 having the trailing edge 28 includes a plurality of second tubercles. In one embodiment, the second tubercles comprise serrations or notches 26 which define individual teeth or chevrons. As the center body 14 rotates along with the swirler vanes 12 during operation, the plurality of serrations or notches 26 helps in reducing separation or a wake region in a boundary layer flow of the combustion fluid between the swirler vanes 12 and around a region of the trailing edge 28. Also, the serrations or notches 26 are expected to create increased turbulence levels which will be translated in terms of lower NOx emissions. In another embodiment, the trailing edge 28 includes a plurality of second tubercles comprising protrusions with sinuous curves. The plurality of second tubercles may also help in generating multiple vortexes for enhancing the mixing of combustion fluid and fuel.

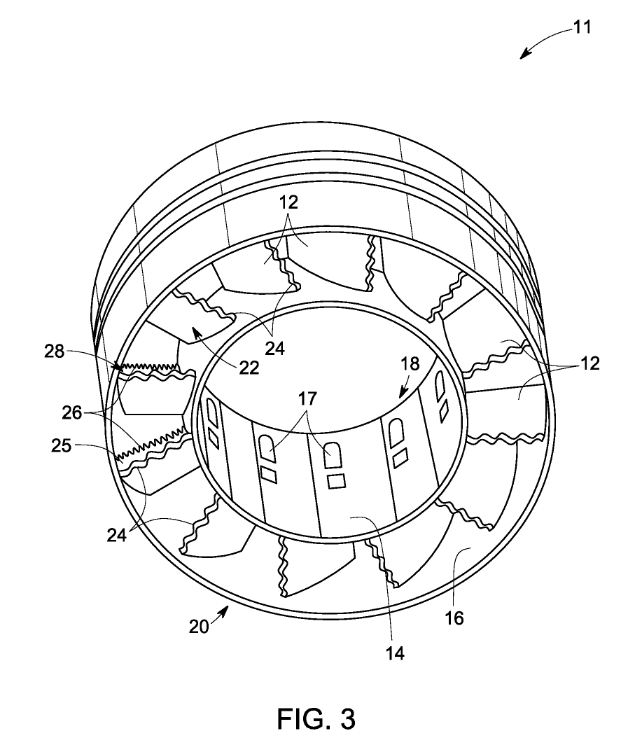

FIG. 3 shows a perspective view of the combustion swirler 11 in accordance with another embodiment of the present invention. The multiple swirler vanes 12 may further include turning sections 25. The turning sections 25 are capable of turning or inducing swirl in the combustion fluid flowing past the swirler vanes 12. A curvature of the turning section creates a pressure differential between a pressure side 18 (that is, the side of the combustion swirler 11 close to a combustion region) and a suction side 20 (that is, a side of the combustion swirler 11 opposite the pressure side) of the swirler vane 12. In this embodiment, the center body 14 with the first annular body portion of the combustion swirler 11 includes one or more center body holes 17 for directing a portion of the combustion fluid through the plurality of center body holes and the multiple swirler vanes 12.

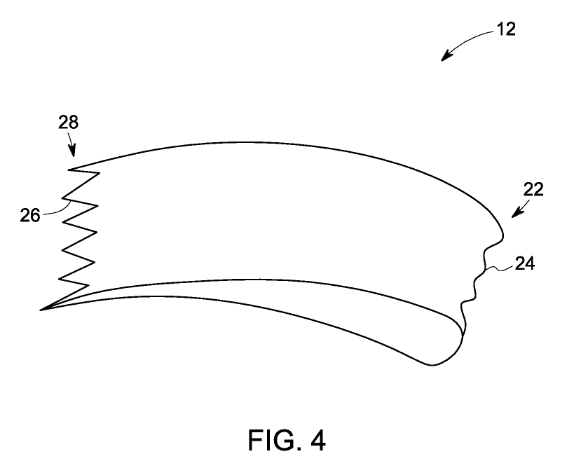

FIG. 4 is a representation of an aerodynamic blade body of a swirler vane 12 of the combustion swirler 11 in accordance with an embodiment of the present invention. The swirler vane 12 includes the plurality of first tubercles 24 arranged on the leading edge 22. In one embodiment, the swirler vane 12 includes a plurality of second tubercles arranged on the trailing edge 28. Using the tubercles on the leading edge 22 and the trailing edge 28 is expected to generate a pair of counter rotating vortices that will maintain the flow of air or the mixture of air and fuel and thus improve flame stability and reduce pressure drop across the combustion swirler 11 (as shown in FIG. 1). The reduction in pressure drop across the combustion swirler 11 occurs due to the use of a lower swirl angle of the swirler vane 12 since the same amount of swirl can be achieved by a smaller swirl angle due to the presence of first tubercles 24 on the leading edge 22.

The plurality of first tubercles 24 may be evenly spaced along the leading edge 22 and provide for improved air and fuel mixing in the combustor over other embodiments for combustion chambers wherein such tubercles are not present on the leading edge of swirler vanes. The tubercles 26 may be evenly spaced along the trailing edge 28 and generate vortexes that enhance the air-fuel mixing in the combustor. The plurality of first tubercles 24 causes stall delays and reduces air flow separation. Further, the plurality of second tubercles 26 results in reduction of a wake region around the trailing edge of swirler vanes. Therefore, the reduction in the wake region helps to lessen the severity of flash back and flame holding. This embodiment also helps mitigate noise generation attributed to flow separation. Moreover, the elimination of the wake region improves the dynamics stability of the combustor section since combustion dynamics generated due to flow break down is alleviated.

Advantageously, the combustion swirler improves the air-fuel mixing as well as flame static stability of the combustor chambers. This is translated in terms of a high pressure drop (such as, for example, about 3%) across the combustion swirler with a combustion region of a gas turbine in accordance with one embodiment. The pressure drop is primarily due to a blockage caused by the combustion swirler. Typically a high swirl angle is chosen to account for the flow separation that occurs at the trailing edge of the combustion swirler. In the present invention, a smaller angle of the swirl vane results in the same degree of swirl and thus the pressure drop is reduced. Consequently, the present invention leads to enhanced performance of the combustion swirler due to the flame static stability and reduced pressure drop.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A combustion swirler comprising:
a plurality of vanes axially extending from an annular first body portion of the combustion swirler,
an annular second body portion of the swirler enclosing the plurality of vanes for directing a flow of combustion fluid;
wherein each of the vanes comprises an aerodynamic blade body comprising a leading edge with a plurality of first tubercles and a trailing edge with a plurality of second tubercles.

2. The combustion swirler of claim 1, wherein the plurality of first tubercles are protrusions with sinuous curves along the leading edge of each of the vanes.

3. The combustion swirler of claim 1, wherein the second tubercles comprise a plurality of serrations or notches having tooth-like protrusions or chevrons.

4. The combustion swirler of claim 1, wherein the plurality of first tubercles are equally spaced on the leading edge of each of the vanes.

5. The combustion swirler of claim 1, wherein the plurality of second tubercles are equally spaced on the trailing edge of each of the vanes.

6. The combustion swirler of claim 1, wherein the plurality of vanes extend from the annular first body portion at an angle ranging from about 25 degrees to about 75 degrees with respect to with respect to a central axial axis along the center of the annular first body portion.

7. The combustion swirler of claim 1, wherein an inner surface of the annular second body portion is attached to the plurality of vanes.

8. The combustion swirler of claim 1, wherein the combustion fluid comprises air or fuel or combinations thereof.

9. The combustion swirler of claim 1, wherein the annular first body portion comprises a plurality of center body holes for directing a portion of the combustion fluid through the plurality of center body holes and the plurality of vanes.

10. A gas turbine comprising:
a combustion swirler located upstream of a combustion region of the gas turbine, the combustion swirler comprising:
a plurality of vanes axially extending from an annular first body portion of the combustion swirler,
an annular second body portion of the combustion swirler enclosing the plurality of vanes for directing a flow of combustion fluid;
wherein each of the vanes comprises an aerodynamic blade body having a leading edge with a plurality of first tubercles and a trailing edge with a plurality of second tubercles.

11. The gas turbine of claim 10, wherein the plurality of first or second tubercles are protrusions with sinuous curves along the leading edge or the trailing edge of each of the vanes.

12. The gas turbine of claim 10, wherein the second tubercles comprise a plurality of serrations or notches having tooth-like protrusions or chevrons.

13. The gas turbine of claim 10, wherein the plurality of first tubercles are equally spaced on the leading edge.

14. The gas turbine of claim 10, wherein the plurality of second tubercles are equally spaced on the trailing edge.

15. The gas turbine of claim 10, wherein the plurality of first tubercles and the plurality of second tubercles are equally spaced on the leading edge and the trailing edge respectively.

16. The gas turbine of claim 10, wherein an inner surface of the annular second body portion is attached to the plurality of vanes.

17. The gas turbine of claim 10, wherein the annular first body portion comprises a plurality of center body holes for directing a portion of the combustion fluid through the plurality of center body holes and the plurality of vanes.
